(19) United States
(12) Patent Application Publication
(10) Pub. No.: US 2026/0273403 A1
(43) Pub. Date: Sep. 17, 2026

(54) VIDEO GAME CONTROLLER-DRIVEN INFORMATION TRANSFER

(71) Applicant: SONY INTERACTIVE ENTERTAINMENT INC., Tokyo (JP)

(72) Inventors: Alex SONG, Palo Alto, CA (US); Daniel HIATT, San Francisco, CA (US); Mayu WATANABE, Los Angeles, CA (US); Chris THIELBAR, El Cerrito, CA (US)

(21) Appl. No.: 19/082,121

(22) Filed: Mar. 17, 2025

(51) Int. Cl. A63F 13/537

(52) U.S. Cl. CPC A63F 13/537

(57) ABSTRACT

Techniques disclosed herein pertain to improving video game system performance. In some examples, a video game controller is wirelessly coupled to a video game console and operating the video game controller includes detecting that an electronic device is within a predetermined distance from the video game controller. In response to detecting that the electronic device is within the predetermined distance from the video game controller, a signal is emitted from the video game controller and a notification indicating that the signal was received by the electronic device is received from the electronic device. In response to receiving the notification, a first message that includes payment method information for a video game player associated with the video game controller is received from the electronic device and a second message that includes the payment method information is transmitted from the video game controller to the video game console.

### BACKGROUND

Video game usage has become prevalent. Often end users will play video games on a portable electronic device such as their mobile phone and on a dedicated video game console. In the case of a mobile phone, video games can be operated using a touchscreen display and buttons of the mobile phone. In the case of a video game console, video games can be operated using an input device such as a video game controller. Managing purchases, personal preferences, and game progress is a desirable feature.

### BRIEF SUMMARY

Techniques disclosed herein pertain to electronic devices. Particularly, techniques disclosed herein pertain to improving electronic devices such as video game consoles using video game controller-driven information transfer.

In some embodiments, a method for operating a video game controller includes: detecting that an electronic device is within a predetermined distance from the video game controller, wherein the video game controller is wirelessly coupled to a video game console; in response to detecting that the electronic device is within the predetermined distance from the video game controller, emitting a signal from the video game controller; receiving a notification from the electronic device, the notification indicating that the signal was received by the electronic device; in response to receiving the notification from the electronic device, receiving a first message from the electronic device, the first message comprising payment method information for a video game player associated with the video game controller; and transmitting a second message from the video game controller to the video game console, wherein the second message comprises the payment method information, and wherein transmitting the second message serves as a response to an event that has occurred at the video game console.

In some embodiments, the method further includes: prior to detecting that the electronic device is within the predetermined distance from the video game controller: receiving an event notification from the video game console, the event notification indicating that the event has occurred at the video game console; and in response to receiving the event notification from the video game console, detecting that the electronic device is within the predetermined distance from the video game controller.

In some embodiments, detecting that the electronic device is within the predetermined distance from the video game controller comprises detecting a signal emitted from the electronic device.

In some embodiments, detecting that the electronic device is within the predetermined distance from the video game controller comprises detecting that the electronic device is communicating with the video game controller using at least one of a Near Field Communication (NFC) protocol or a Bluetooth protocol.

In some embodiments, detecting that the electronic device is within the predetermined distance from the video game controller comprises detecting that the electronic device has physically contacted the video game controller.

In some embodiments, the notification further indicates that an application associated with a provider of the video game console is executing on the electronic device.

In some embodiments, the signal comprises at least one of an audible signal emitted from an audio transducer of the video game controller, a visual signal emitted from a light emitting unit of the video game controller, a vibration signal emitted from a vibrating unit of the video game controller, or a combination thereof.

Some embodiments include a video game controller that includes one or more processors and one or more computer-readable media storing instructions which, when executed by the one or more processors, cause the video game controller to perform part or all of the operations and/or methods disclosed herein.

Some embodiments include one or more non-transitory computer-readable media storing computer-readable instructions that, when executed by one or more processors, cause a video game controller to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Features, embodiments, and advantages of the present disclosure are better understood when the following Detailed Description is read with reference to the accompanying drawings.

FIG. 1 illustrates a computer system that presents a dashboard, according to some embodiments of the present disclosure.

FIG. 2 illustrates an example of a video game controller, according to some embodiments of the present disclosure.

FIG. 3 illustrates another example of a video game controller, according to some embodiments of the present disclosure.

FIGS. 4A-4E illustrates an example of a video game controller-driven information transfer flow, according to some embodiments of the present disclosure.

FIG. 5 illustrates another example of a video game controller-driven information transfer flow, according to some embodiments of the present disclosure.

FIG. 6 illustrates another example of a video game controller-driven information transfer flow, according to some embodiments of the present disclosure.

FIG. 7 illustrates another example of a video game controller-driven information transfer flow, according to some embodiments of the present disclosure.

FIG. 8 illustrates another example of a video game controller-driven information transfer flow, according to some embodiments of the present disclosure.

FIG. 9 illustrates another example of a video game controller-driven information transfer flow, according to some embodiments of the present disclosure.

FIG. 10 illustrates an example of a process for operating a video game controller to perform video game controller-driven information transfer, according to some embodiments of the present disclosure.

FIG. 11 illustrates another example of a process for operating a video game controller to perform video game controller-driven information transfer, according to some embodiments of the present disclosure.

FIG. 12 illustrates an example of a computer system suitable for implementing techniques of the present disclosure, according to some embodiments of the present disclosure.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Video game players have found it desirable to store payment method information and account information such as credit account information, bank account information, gift card information, digital wallet identification information, crypto wallet identification information, and associated credentials in their accounts for facilitating and managing video game purchases, video game credits, in-app purchases, and the like. Video game players have also found it desirable to maintain player accounts to keep track of purchases, personal preferences, game preferences and progress, and the like. Video game players have also found it desirable to collectively participate in a video game experience with other video game players. In response, various entities such as Sony Interactive Entertainment Inc. have provided portals for providing such features. Use of these portals has facilitated many desirable features such as streamlining payments and video game console setup, sharing video game play between devices, persisting user preferences between devices and gaming environments.

To utilize these portals, video game consoles often offer login functionality where end users can log into the video game consoles and/or utilize the video game consoles to log into their accounts (e.g., accounts provided by video game providers, video game console providers, and the like). Once logged into their accounts, video game players can then manage payment methods, past purchases, personal preferences, game progress accomplishments, and the like.

Traditionally, to facilitate and coordinate these operations, video game consoles perform multiple operational steps using multiple devices. For example, a video game console may perform one or more first communication operations with a video game controller and one or more second communication operations with a mobile phone or electronic keyboard. In another example, a video game console may present a screen of a software application executing on the video game console (e.g., a separate software application or a component of the operating system of the video console) in response to operations performed by a video game controller in communication with the video game console yet present a quick response code on a display for scanning and verification by a separate mobile device. In yet another example, the video game console may obtain login and/or payment credentials from an electronic keyboard in communication with the video game console yet depend on the video game controller to navigate to and from a login screen.

However, facilitating and coordinating these operations by performing multiple operational steps using multiple devices often causes performance of the video game console to suffer and/or one or more operations of the video game console to fail. For example, wireless communication challenges may cause communication between a video game console and one or more of the devices to fail thereby leading to failure of an operation or one or more devices may be incompatible with the video game console and/or an operating system of the video game console thereby leading to a slowdown in an operation. In another example, coordinating multiple operations between multiple devices may cause processing components of a video game console to become overworked and/or overheat thereby causing processing slowdowns, limiting the video game console’s ability to perform multiple overlapping operations, and even video game console failure.

The techniques described herein overcome the foregoing challenges and others by providing video game controller-driven information transfer. Particularly, techniques disclosed herein improve video game consoles and video game console performance by utilizing video game controller-driven information transfer operations. In some implementations, a video game controller can be operated, and operating a video game controller can include detecting that an electronic device is within a predetermined distance from the video game controller. A video game console can be wirelessly coupled to the video game controller, and, in response to detecting that the electronic device is within the predetermined distance from the video game controller, the video game controller can emit a signal. In some implementations, prior to detecting that the electronic device is within the predetermined distance from the video game controller, the video game controller can receive an event notification from the video game console. The event notification indicating that the event has occurred at the video game console, and, in response to receiving the event notification from the video game console, the video game controller can detect that the electronic device is within the predetermined distance from the video game controller.

In some implementations, the video game controller can detect that the electronic device is within the predetermined distance from the video game controller by, in some examples, detecting a signal emitted from the electronic device, using a communication protocol such as a Near Field Communication (NFC) protocol and/or a Bluetooth protocol, detecting that the electronic device has physically contacted the video game controller, and a combination thereof. In some implementations, the signal can include at least one of an audible signal emitted from an audio transducer of the video game controller, a visual signal emitted from a light emitting unit of the video game controller, a vibration signal emitted from a vibrating unit of the video game controller, or a combination thereof.

A notification can be received from the electronic device, and the notification can indicate that the signal was received by the electronic device. In some implementations, the notification further indicates that an application associated with a provider of the video game console is executing on the electronic device. In response to receiving the notification from the electronic device, the video game controller can also receive a message from the electronic device. The message can include payment method information for a video game player associated with the video game controller. The video game controller can then transmit a message that includes the payment method information to the video game console. The message can serve as a response to the event.

By using the techniques described herein, video game consoles can be improved. Particularly, by providing video game controller-driven information transfer operations, the challenges involved with the traditional techniques can be overcome. For example, by providing video game controller-driven information transfer operations, the number of devices and the number of operational steps performed by the video game console can reduced, thereby simplifying the operations performed by the video game console and reducing the likelihood of failure of any one operation of video game console performance. Additionally, by providing video game controller-driven information transfer operations, the opportunity for device communication failures and processing overload can be reduced, thereby reducing the likelihood of processing slowdowns and/or video game console failure.

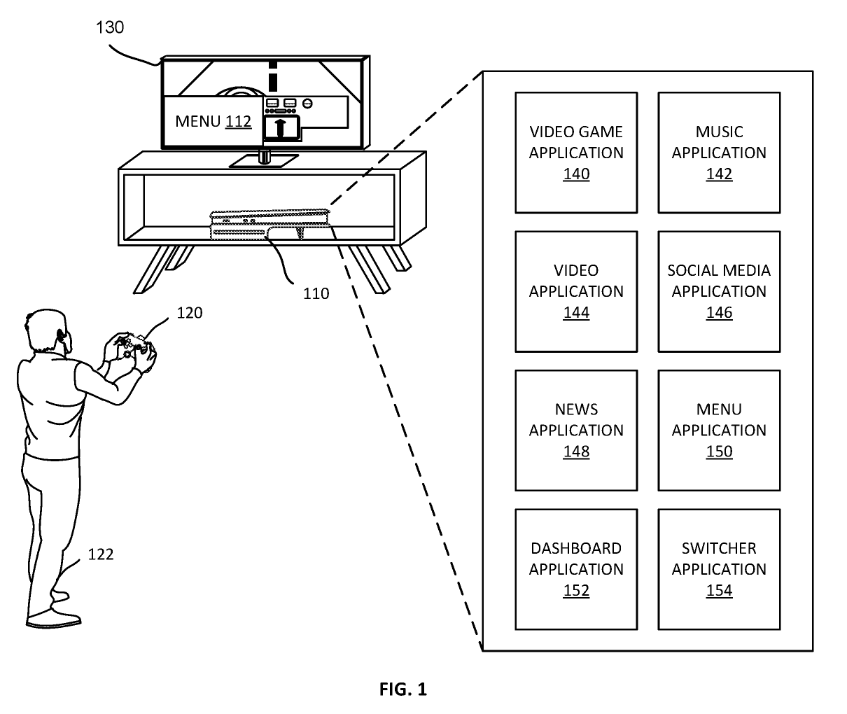

FIG. 1 illustrates a computer system that presents a dashboard, according to an embodiment of the present disclosure. As illustrated, the computer system includes a video game console 110, a video game controller 120, and a display 130. Although not shown, the computer system may also include a backend system, such as a set of cloud servers, that is communicatively coupled with the video game console 110. The video game console 110 is communicatively coupled with the video game controller 120 (e.g., over a wireless network) and with the display 130 (e.g., over a communications bus). A video game player 122 operates the video game controller 120 to interact with the video game console 110. These interactions may include playing a video game presented on the display 130, interacting with a dashboard 112 presented on the display 130, and interacting with other applications of the video game console 110 (e.g., with media applications to stream media from an online content source or to play a media file from the local storage of the video game console 110).

The video game console 110 includes one or more processors and one or more memories (e.g., a non-transitory computer-readable storage medium) storing computer-readable instructions that can be executed by the one or more processors and that, upon execution by the one or more processors, cause the video game console 110 to perform various operations (e.g., operations related to various applications). In particular, the computer-readable instructions can correspond to program codes for the various applications of the video game console 110 including video game application 140, music application 142, video application 144, social media application 146, and news application 148. A video game application, such as video game application 140, generally represents a computer application executable to present video game content, receive user interaction with the video game content, and accordingly update the video game content. A media application, such as music application 142, video application 144, social media application 146, and news application 148, generally represents a computer application executable to present media content including audio, video, and/or other media types, receive user interaction with the media content, and accordingly update the media content. The media content can be streamed from a remote content source or can be presented from local storage of the video game console 110. Further, other applications can be likewise included in the video game console 110, such as a chat application. The availability of a video game application, media application, and/or other type of computer application to the video game player 122 via the video game console 110 can depend on a user identifier of the video game player 122 (e.g., upon a login to the video game console 110, the availability of the computer applications can depend on the user identifier used in the login).

The video game console 110 also includes a menu application 150, a dashboard application 152, and a switcher application 154. The menu application 150 can present user interfaces (UIs) in a GUI of the display 130. One or more UIs of the UIs presented by the menu application 150 can facilitate logging into the video game console 110, guiding a login process for logging into the video game console 110, presenting information associated with logging into the video game console 110, and the like. For example, one UI of the UIs presented by the menu application 150 can present fields for entering account credentials (e.g., a user identifier and a password) and/or entering payment method information (e.g., account numbers, expiration dates, security codes). In another example, another UI of the UIs presented by the menu application 150 can present information for creating and managing a user profile account. In yet another example, a subset of UIs of the UIs presented by the menu application 150 can facilitate and/or guide an end user through a process for entering payment method information into the video game console 110. The dashboard application 152 can present an arrangement of interactive UI widgets in a dashboard page on the GUI. The switcher application 154 can present a ribbon of UI elements in a ribbon menu on the GUI to allow scrolling between different UI elements and switching between corresponding applications.

The video game controller 120 is an example of an input device. The video game controller 120 may allow the user 122 to interact with one or more GUIs presented by the video game console 110 on the display 130. For example, using one or more directional control inputs (e.g., a joystick and/or a directional pad) the user can navigate to and within various menus, dashboards, and UI elements. Other types of the input device are possible including, a keyboard, a touchscreen, a touchpad, a mouse, an optical system, a microphone, a camera, or other user devices suitable for receiving input of a user. For example, a microphone may allow the user 122 to interact with the GUIs using various voice commands. As another example, a camera may allow the user 122 to interact with the GUIs using various gesture commands.

Upon an execution of the video game application 140 by the video game console 110, a rendering process of the video game console 110 presents video game content (e.g., illustrated as a car race video game content) on the display 130. Upon user input from the video game controller 120 (e.g., a user push of a particular key or button), the rendering process also presents the menu 112. Additionally, or alternatively, the menu 112 may be presented as an initial landing page in response to a user powering-on the video game console 110 and/or waking the video game consol 110 from a suspended state. Depending on the user input, the menu 112 corresponds to the home UI page, a landing page, or the like. The menu 112 can be presented in a layer over the video game content.

Upon the presentation of the menu 112, the user control changes from the video game application 140 to the menu application 150. Upon receiving a user input from the video game controller 120 requesting interactions with the menu 112, an underlying application (e.g., the menu application 150, the dashboard application 152, or the switcher application 154 as applicable) supports such interactions by updating the menu 112 and launching any relevant application in the background or foreground. The video game player 122 can exit the menu 112 or automatically dismiss the menu 112 upon the launching of an application in the background or foreground. Upon exiting the menu 112 or the dismissal based on a background application launch, the user control changes from the underlying application to the video game application 140.

The dashboard application 152, when executed, may generate a dashboard (e.g., a “widget menu,” “landing page,” and/or “explore page”) configured to present information from applications and services available to the video game console 110 as interactive UI widgets. The term “widget” is used herein as an example of an interactive UI element generated and/or presented by the dashboard application 152 and corresponding to an application or service of the computer system. Other implementations to present a UI element are possible, including any type of icon, whether a widget, a tile, a thumbnail, a text description, a multiple column element with textual or graphical description in each column, and the like. Widgets may be presented with application information and/or dynamic content presented with the widget in a media library. For example, the dashboard application 152 may generate and/or present widgets associated with media applications, system applications and/or services, video game applications, or the like. The dashboard application 152 may be executed via multiple avenues of ingress. For example, the dashboard application 152 may be executed by a pre-defined user interaction (e.g., via controller 120, a voice command from the video game player 122, activating and/or powering-on the video game consol 110 etc.) and/or by navigating one or more menus and/or sub-menus of the video game console 110 (e.g., menu 112).

In general, the switcher application 154 may facilitate selection of a first subset of tiles to present in an immediate selection area of a library interface, as described in more detail below. The switcher application 154 may populate the first subset of tiles with tiles associated with system applications, video game applications, other forms of content, etc.

Although FIG. 1 illustrates that the different applications are executed on the video game console 110, the embodiments of the present disclosure are not limited as such. Instead, the applications can be executed on the backend system (e.g., the cloud servers) and/or their execution can be distributed between the video game console 110 and the backend system.

In the interest of clarity of explanation, the embodiments may be described in connection with a video game system including a video game console. However, the embodiments are not limited as such and similarly apply to any other type of a computer system. Generally, a computer system presents a dashboard in a GUI on a display. The dashboard presents UI elements, each corresponding to an application, service, or collection of information.

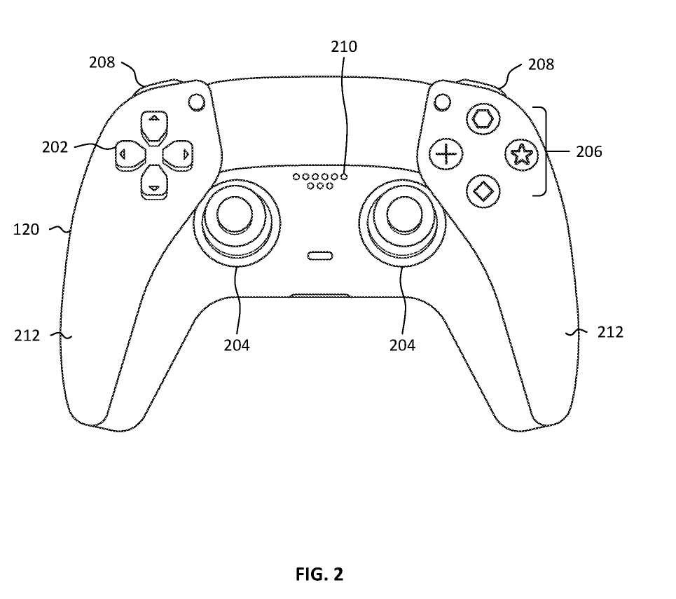

FIG. 2 illustrates an example of a video game controller. As shown in FIG. 2, the video game controller 120 can include mechanisms for providing input to the video game console 110. For example, the video game controller 120 can include a directional pad 202, joysticks 204, buttons 206, and triggers 208. Any combination of the directional pad 202, one or both of the joysticks 204, one or more of the buttons 206, and one or both of the triggers 208 can be used by an end user (e.g., a video game player) to provide input to the video game console 110. The video game controller 120 can also include handles 212, which can be used to hold or grip the video game controller 120 while an end user operates the video game controller 120 to provide the input the video game console 110. The video game controller 210 can also include ports 210 that enable audio transducers included in the video game controller 120 to record sounds in an environment surrounding the video game controller 120 and emit audio to the environment surrounding the video game controller 120. Although not shown, the video game controller 120 can include other components such as one or more touch sensors for detecting physical touching of the video game controller 120 (e.g., by a human, another video game controller, an electronic device, and the like), display screens for displaying content (e.g., control and video game content) and receiving input to the video game controller 120 (e.g., touchscreen input), light sources (e.g., light emitting diodes) for emitting light and other signals to the environment surrounding the video game controller 120, and the like. The foregoing mechanisms of the video game controller 120 are not intended to be limiting and other mechanisms may be included in the video game controller 120.

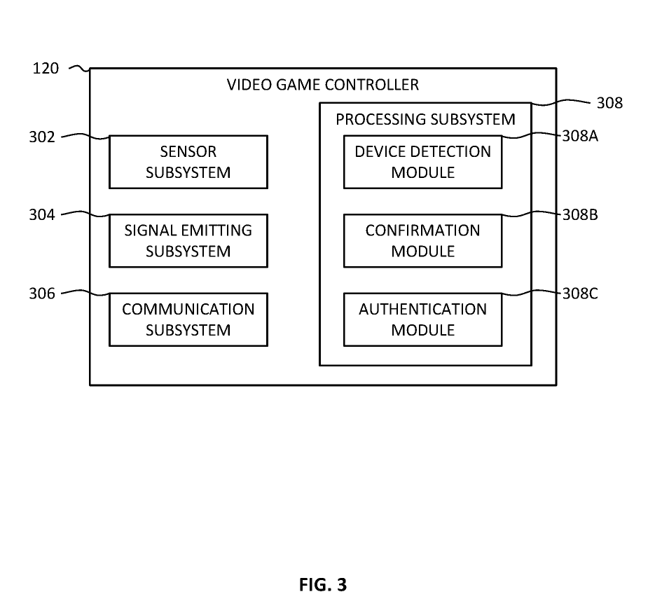

FIG. 3 illustrates another example of a video game controller. As shown in FIG. 3, the video game controller 120 can include a sensor subsystem 302, a signal emitting subsystem 304, and a communication subsystem 306, and a processing subsystem 308.

The sensor subsystem 302 can include sensors for sensing an operation of the video game controller 120, an external environment of the video game controller 120 (e.g., an environment surrounding the video game controller 120), an internal environment of the video game controller 120 (e.g., an environment within the video game controller 120), and the like. Examples of the sensors included in the sensor subsystem 302 can include, but are not limited to, image sensors, infrared sensors, depth cameras, event detection sensors, light sensors, microphones, sound sensors, audio transducers, position determining sensors, ultrawide band sensors, magnetic sensors, orientation sensors, proximity sensors, accelerometers, gyroscopes, inertial measurement units (IMUs), and the like.

The signal emitting subsystem 304 can include devices for emitting signals. A signal emitted by a device or devices of the signal emitting subsystem 304 can include a light component (e.g., visible and/or infrared light), an audible component (e.g., a sound), and/or a haptic feedback component (e.g., a vibration). Examples of light that can be included as a component of a signal emitted by a device or devices of the signal emitting subsystem 304 include visible light, infrared light, laser light, steady light, strobe light, flashing light, colored light, light patterns, light beams, modulated light, and the like. Examples of audio that can be included as a component of a signal emitted by a device or devices of the signal emitting subsystem 304 include sounds, noises, music, tones, chimes, songs, ringtones, variable volume audio, and the like. Examples of haptic feedback that can be included as a component of a signal emitted by a device or devices of the signal emitting subsystem 304 include vibrations, surface frictions, thermal feedback, electromagnetic feedback, ultrasonic feedback, and the like. Examples of devices included in the signal emitting subsystem 304 can include, but are not limited to, audio transducers such as speakers, light sources such as LEDs, haptic feedback devices such as a vibrator, and others.

The communication subsystem 306 can include various hardware such as circuitry, radios, modules, transceivers, and software for enabling the video game controller 120 to communicate using wireless and/or wired communication. For example, the various hardware and software can enable the video game controller 120 to communicate with a network, a cloud-based storage system, another device such as another video game controller, electronic device, mobile phone, input device, video game console, and the like. The various hardware and software can also enable the video game controller 120 to communication using any wired and/or wireless communication technology, standard, protocol, and the like, and using any kind of network, public or private, wired or wireless, and the like. Examples of such technologies, standards, and protocols include NFC, Bluetooth, IrDA; RFID; Matter; ZigBee; 3G; 4G; 5G; 6G; WLAN; Z-wave; Wi-Fi and Wi-Fi Direct; UWB; USB; ANT and ANT+; UHF; VHF; SCPS; and the like.

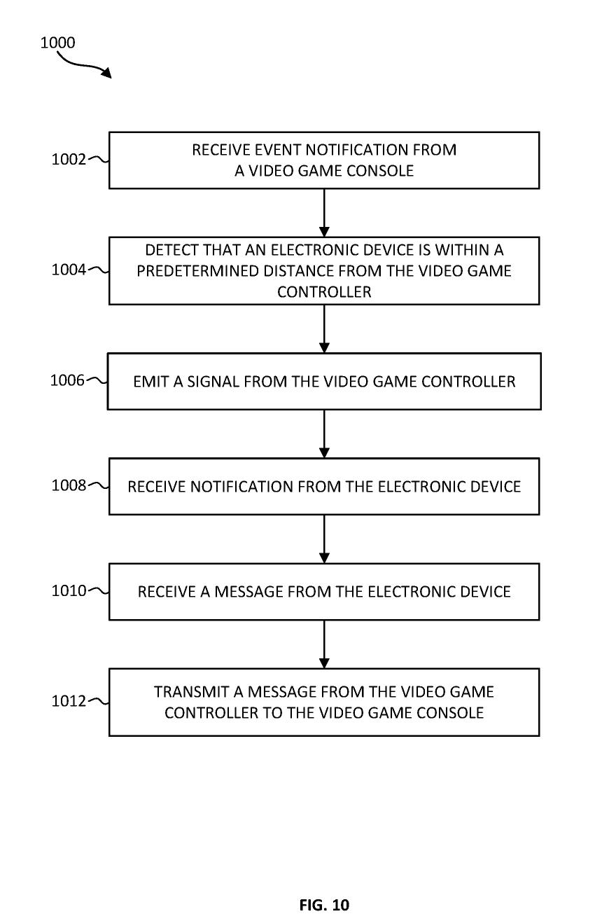

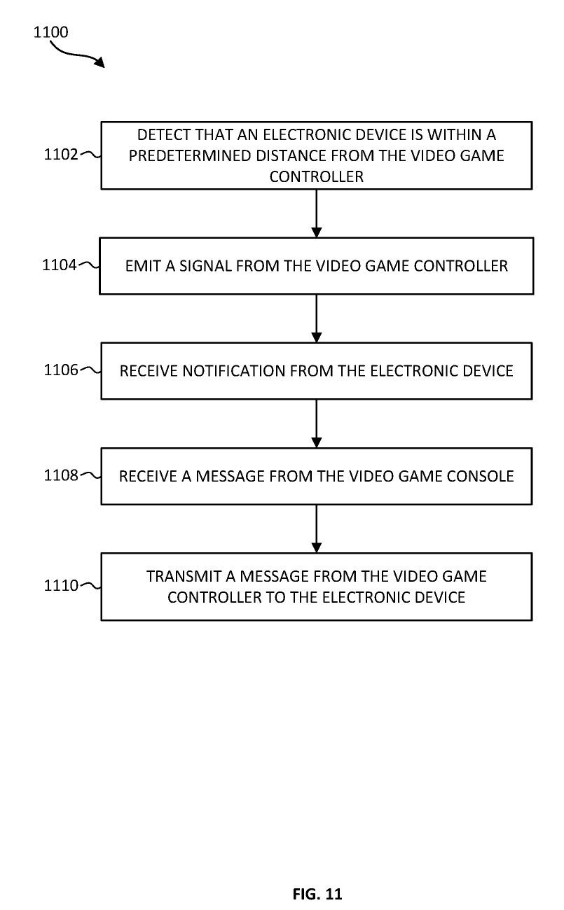

The processing subsystem 308 can include one or more processors (not shown) and one or more memories (not shown). The one or more processors can read one or more programs from the one or more memories and execute them. Each processor of the one or more processors can be of any type of processor. Examples of processors include, but are not limited to, microprocessors, microcontrollers, graphical processing units, digital signal processors, application-specific integrated circuits, field programmable gate arrays, or any combination thereof. Additionally, each processor of the one or more processors can include multiple cores, arrays, coprocessors, local cache memory layers, and the like. Each memory of the one or more memories can be non-volatile and can include any type of memory or memory device that retains stored information when powered off. At least one memory of the one or more memories can include a non-transitory computer-readable storage medium from which the one or more processors can read instructions. Examples of memories, memory devices, computer-readable storage media include, but are not limited to, include electrically erasable and programmable read-only memory, flash memory, magnetic disks, memory chips, read-only memory, RAM, an ASIC, a configured processor, optical storage, and the like. The one or more processors, either individually or collectively, can execute programs stored in the one or more memories to perform the operations and/or methods, including parts thereof, described throughout. For example, the one or more processors can execute programs stored in the one or more memories to perform the processes 1000, 1100 for operating a video game controller to perform video game controller-driven information transfer as shown in FIGS. 10 and 11 below and to be described later.

In some implementations, the processing subsystem 308 can include, but is not limited to, a device detection module 308A, a confirmation module 308B, and an authentication module 308C. Each of the device detection module 308A, the confirmation module 308B, and the authentication module 308C can be implemented in hardware (e.g., a processor, computer circuitry, and the like), software, or a combination thereof.

The device detection module 308A can be configured to detect whether an electronic device is within a predetermined distance from the video game controller 120. Examples of electronic devices include, but not are not limited to, video game controllers, mobile phones, computing devices such as tablet computers, laptop computers, and the like, video game consoles, wearable devices, and the like. In some implementations, the predetermined distance can be 0, 1, 2, 3, 4, 5, 6, 7, 8, 9, 10, 11, or 12 inches or any distance therebetween. The device detection module 308A can detect that the electronic device is within the predetermined distance from the video game controller 120 by detecting a signal that is emitted from the electronic device. In some implementations, the device detection module 308A can detect that an electronic device is within a predetermined distance from the video game controller 120 in response to and/or after the video game controller 120 receives a notification. In some implementations, the signal can be an audio signal, a light signal, or a combination thereof. In some implementations, the device detection module 308A can detect that the electronic device is within the predetermined distance from the video game controller 120 by decoding an optical pattern depicted by an image captured by the video game controller 120. For example, the device detection module 308A can be configured to control an image sensor of the sensor subsystem 302 to capture an image of an optical pattern (e.g., a quick response, QR, code) associated with the electronic device and/or presented by the electronic device (e.g., on a display of the electronic device) and decode the optical pattern (e.g., decode the optical pattern in code data).

In some implementations, in the case the electronic device emits an audio signal, the device detection module 308A can detect the emitted audio signal (e.g., using one or more audio transducers included in the sensor subsystem 302). In some implementations, to determine whether the electronic device is within the predetermined distance from the video game controller 120, the device detection module 308A can determine whether the audio signal emitted by the electronic device has a particular frequency and/or a particular amplitude. In the event that the audio signal emitted by the electronic device has the particular frequency and/or the particular amplitude, the device detection module 308A can determine that the electronic device is within the predetermined distance from the video game controller 120.

In some implementations, in the case the electronic device emits a light signal, the device detection module 308A can detect the emitted light signal (e.g., using one or more image sensors and/or light sensors of the sensor subsystem 302). In some implementations, to determine whether the electronic device is within the predetermined distance from the video game controller 120, the device detection module 308A can determine whether the light signal emitted by the electronic device has a particular frequency, a particular intensity (e.g., brightness), and/or a particular pattern. In the event that the light signal emitted by the electronic device has the particular frequency, the particular intensity, and/or the particular pattern, the device detection module 308A can determine that the electronic device is within the predetermined distance from the video game controller 120.

In some implementations, the device detection module 308A can detect that the electronic device is within the predetermined distance from the video game controller by detecting that the electronic device is communicating with the video game controller 120 using at least one of a Near Field Communication (NFC) protocol or a Bluetooth protocol. In some implementations, the video game controller can be wirelessly paired with and/or wirelessly coupled to the electronic device using the communication subsystem 306 and using a wireless pairing and/or coupling protocol such as the NFC protocol or Bluetooth protocol and the electronic device can be considered to be communicating with the video game controller 120 when the video game controller 120 is wirelessly paired with and/or wirelessly coupled to the electronic device. In some implementations, to determine whether the electronic device is within the predetermined distance from the video game controller 120, the device detection module 308A can determine whether the video game controller 120 is wirelessly paired with and/or wirelessly coupled to the electronic device using the NFC protocol and/or the Bluetooth protocol, and, in the event that the video game controller 120 detects that the video game controller 120 is wirelessly paired with and/or wirelessly coupled to the electronic device using the NFC protocol and/or the Bluetooth protocol, the device detection module 308A can determine that the electronic device is within the predetermined distance from the video game controller 120.

The device detection module 308A can also detect that the electronic device is within the predetermined distance from the video game controller 120 by detecting that the electronic device is in physical contact with the video game controller 120 and/or has physically contacted the video game controller 120. In some implementations, the electronic device can be brought into physical contact with the video game controller 120 and the device detection module 308A can detect the electronic device is in physical contact with and/or has physically contacted the video game controller 120. The device detection module 308A can detect whether the electronic device is in physical contact with and/or has physically contacted the video game controller 120 using one or more sensors of the sensor subsystem 302 (e.g., proximity sensors, IMUs) and/or a wireless communication transceiver (e.g., a Bluetooth-enabled radio, an NFC-enabled radio) of the communication subsystem 306. In some implementations, to determine whether the electronic device is in physical contact with and/or has physically contacted the video game controller 120, the device detection module 308A can obtain a signal from the wireless communication transceiver and use the signal obtained from the wireless communication transceiver to determine that an electronic device is within a close distance to the video game controller 120 (e.g., 0, 1, 3, 4 inches or anything distance therebetween). In the event the device detection module 308A determines that the electronic device is within a close distance to the video game controller 120, the device detection module 308A can obtain one or more signals from the one or more sensors and use the one or more signals obtained from the one or more sensors to determine that the electronic device is in physical contact with and/or has physically contacted the video game controller 120. For example, the device detection module 308A can obtain a signal from the wireless communication transceiver of the communication subsystem 306, use that signal to determine that the electronic device is within a close distance to the video game controller 120, obtain a signal from a proximity sensor of the sensor subsystem 302, and use that signal to determine that the electronic device is in physical contact with (e.g., touching) the video game controller 120. In another example, the device detection module 308A can obtain a signal from the wireless communication transceiver of the communication subsystem 306, use that signal to determine that the electronic device is within a close distance to the video game controller 120, obtain signals from an IMU of the sensor subsystem 306, and use those signals to determine that the electronic device has physically contacted the video game controller 120 while the electronic device is or was within a close distance to the video game controller 120.

In some implementations, in the case the electronic device presents an optical pattern (e.g., presents a QR code on a display of the electronic device and/or on a body of the electronic device), the device detection module 308A can capture an image of the optical pattern (e.g., using one or more image sensors of the sensor subsystem 302). In some implementations, to determine whether the electronic device is within the predetermined distance from the video game controller 120, the device detection module 308A can determine whether the optical pattern can be decoded. In the event that the optical pattern depicted in the captured image can be decoded by the device detection module 308A, the device detection module 308A can determine that the electronic device is within the predetermined distance from the video game controller 120.

The confirmation module 308B can be configured to receive notifications. In some implementations, the notifications can be received from a video game console such as the video game console 110. In some implementations, the notifications received from the video game console can indicate that an event has occurred at the video game console. In some implementations, the event can correspond to a login inquiry generated by the video game console for logging into the video game console, logging into a video game executing on the video game console, and logging into other components. In some implementations, the event can correspond to a payment method inquiry generated by the video game console. The payment method inquiry can be an inquiry for adding payment method information (e.g., credit account information, bank account information, gift card information, digital wallet identification information, crypto wallet identification information, and associated credentials) to an account associated with the video game console, a video game executing on the video game console 110, a user of the video game console and/or the video game. In some implementations, the payment method inquiry can be an inquiry for managing a payment method associated with an account of the video game console, a video game executing on the video game console 110, a user of the video game console and/or the video game.

In some implementations, the notifications can be received from an electronic device such as the electronic device described above. In some implementations, the notifications received from the electronic device can indicate that a signal emitted by the video game controller 120 was received by the electronic device. In some implementations, the notification can also indicate that an application associated with a provider of the video game console is executing on the electronic device. In some implementations, the notification can be generated automatically by the electronic device in response to receiving the signal emitted by the video game controller 120 while an application associated with a provider of the video game console 110 is executing on the electronic device. In some implementations, the notification can be generated by the electronic device in response to an end user acknowledging the signal emitted by the video game controller 120 while using an application associated with a provider of the video game console that is executing on the electronic device and during a time in which the signal is emitted by the video game controller 120.

As described above, the video game controller 120 can be configured to communicate using wireless communications and/or wired communications. In the case, the video game console is wirelessly coupled to the video game controller 120 or the electronic device, the confirmation module 308B can receive the notifications using a wireless transceiver of the communication subsystem 306. In the case the video game console is couple to the video game controller 120 or the electronic device using a wired connection, the confirmation module 308B can receive the notifications using a wired transceiver of the communication subsystem 306.

The confirmation module 308B can be configured to emit signals. In some implementations, the signal can be an audible signal (e.g., a sound output by an audio transducer of the signal emitting subsystem 304), a visual signal (e.g., a light emitted by a light source of the signal emitting subsystem 304), a vibration signal (e.g., a rumble emitted by a vibrator of the signal emitting subsystem 304), or a combination thereof. In some implementations, the signal can be emitted in response to the device detection module 308A detecting that an electronic device is within a predetermined distance from the video game controller 120.

The authentication module 308C can be configured to receive a message from the electronic device. In some implementations, the message includes payment method information for a video game player associated with the video game controller 120. In some implementations, the video game player can be an end user of the video game console, an end user of the electronic device, an end user of the video game controller 120, or a combination thereof. In some implementations, the video game player can be human video game player or computerized (e.g., artificially intelligent) video game player (e.g., a bot). In some implementations, the payment method information for the video game player can be obtained from a server (e.g., a cloud-based storage server) storing payment method information for video game players, the electronic device, or a combination thereof. For example, the authentication module 308C can use a wireless or wired transceiver of the communication subsystem 306 to communicate with the server and/or the electronic device to receive the message from the server and/or the electronic device. In some implementations, the payment method information can used to facilitate and manage video game purchases, video game credits, in-app purchases, and the like. In some implementations, the authentication module 308C can receive the message in response to and/or after a notification is received from the electronic device.

The authentication module 308C can also be configured to transmits a message to the video game console. In some implementations, the message includes the payment method information and transmitting the message serves as a response to the event. The authentication module 308C can transmit the message to the video game console using a wireless communication transceiver of the communication subsystem 306. In some implementations, the payment method information can be used by the video game console to facilitate and manage video game purchases, video game credits, in-app purchases, and the like.

The foregoing subsystems of the video game controller 120 are not intended to be limiting and other subsystems may be included in the video game controller 120.

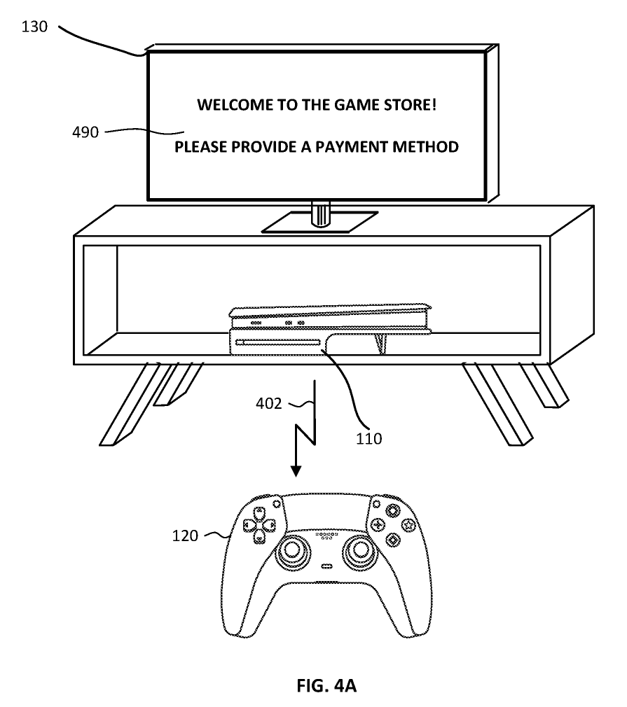

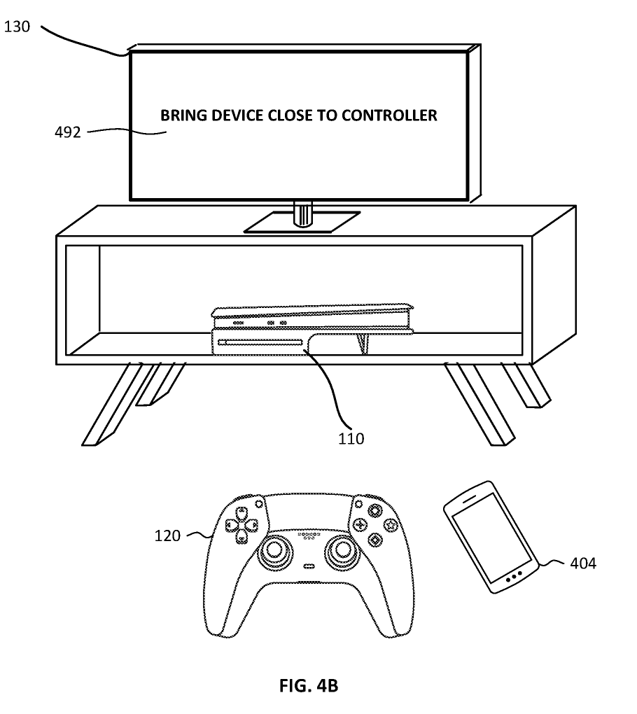

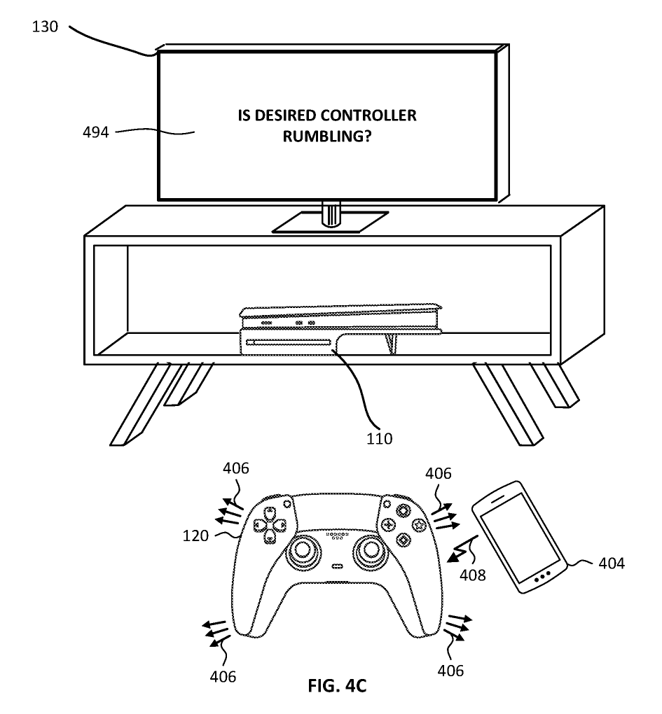

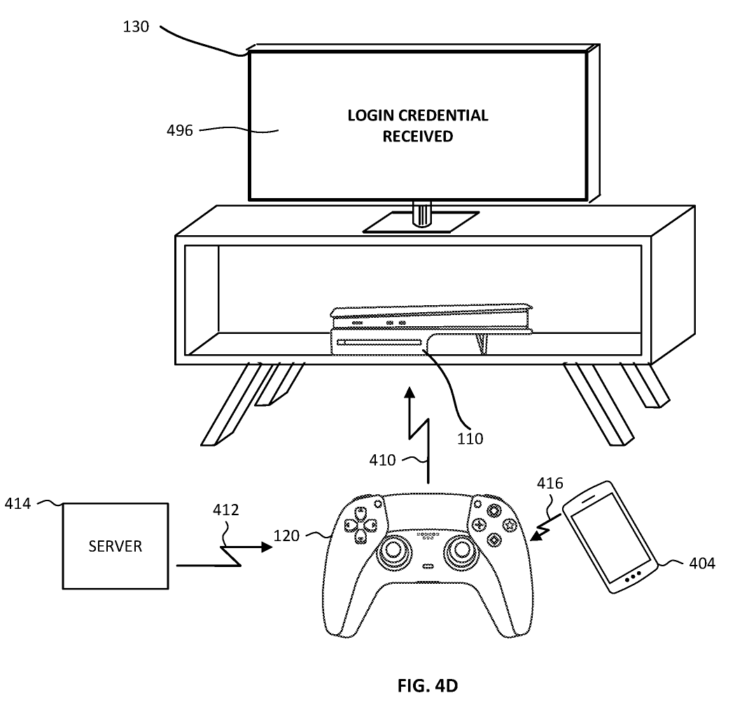

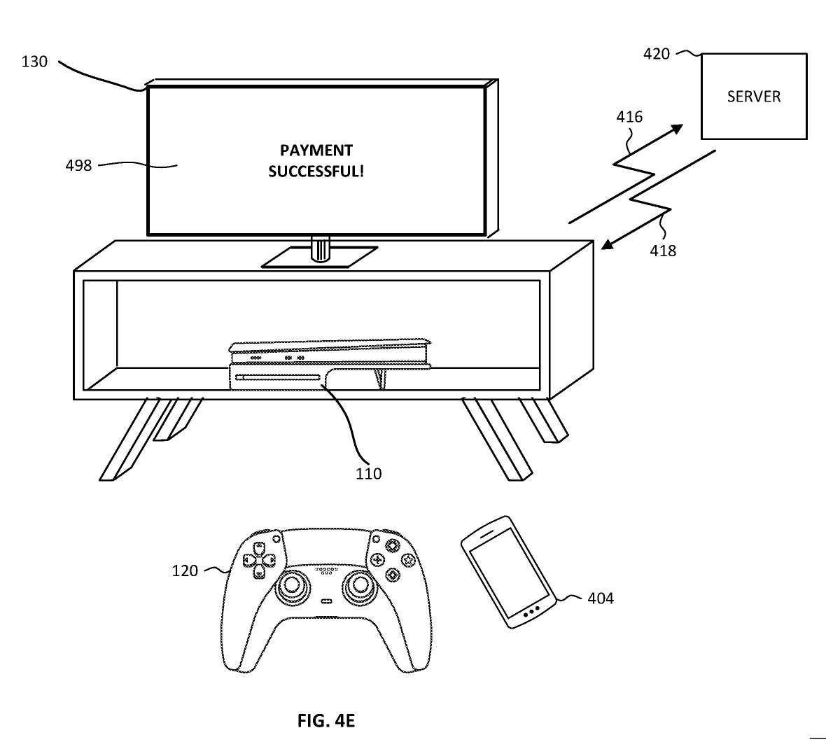

FIGS. 4A-4E illustrates an example of a flow for video game controller-driven information transfer. In some implementations, the flow for video game controller-driven information transfer can be performed by the video game controller 120.

As shown in FIG. 4A, the flow begins with an event that has occurred at the video game console 110. In some implementations, the event corresponds to a payment method inquiry generated by the video game console 110 for facilitating the acquisition of payment method information by the video game console and/or a video game executing on the video game console. In some implementations, the payment method inquiry facilitates the acquisition of payment method information from a video game controller, an electronic device communicatively coupled to the video game console and/or the video game controller, a server communicatively coupled to the video game console and/or the video game controller, an end user of the video game console, the video game controller, and/or the electronic device, and/or some other source. For example, the video game console 110 can generate a GUI 490 and present the GUI 490 on the display 130. The GUI 490 can present the payment method inquiry generated by the video game console 110. After the event has occurred and/or in response to the event occurring, the video game console 110 can transmit a notification 402 to the video game controller 120.

As shown in FIG. 4B, after transmitting the notification 402 and/or in response to transmitting the notification 402, the video game console 110 can generate a GUI 492 and present the GUI 492 on the display 130. The GUI 492 can present an instruction associated with the payment method inquiry. For example, as shown in FIG. 4B, the instruction can instruct a viewer of the display 130 (e.g., a video game player or end user of the video game controller) to bring electronic device 404 close to the video game controller 120.

As shown in FIG. 4C, the video game controller 120 can detect that an electronic device 404 is within a predetermined distance from the video game controller and emit a signal 406 after the detection and/or in response to the detection. The signal can serve as an indicator that the electronic device 404 is close to the video game controller 120. As shown in FIG. 4C, the signal 406 is a visual signal, but, as described throughout, this is not intended to be limiting, and any kind of signal can be emitted to serve as a confirmation that the electronic device 404 is close to the video game controller 120. After generating and presenting the GUI 492, the video game console 110 can generate and present GUI 494. The GUI 494 can present an inquiry associated with the emitted signal. For example, in the case the emitted signal is a vibration, the video game console 110 can present an inquiry associated with the vibration (e.g., “Is desired controller rumbling?”). After the video game controller 110 emits the signal and/or in response to the video game controller 110 emitting the signal, the electronic device 404 can transmit a notification 408 to the video game controller 120. The notification 408 can indicate that the signal emitted by the video game controller 120 was received by the electronic device 404. In some implementations, the notification can also indicate that an application associated with a provider of the video game console 120 and/or operating system of the electronic device 404 is executing on the electronic device 404 (e.g., a digital wallet application, video game system application, and the like). In some implementations, the notification can be generated automatically by the electronic device 404 in response to receiving the signal while the application and/or operation system is executing on the electronic device 404. In some implementations, the notification can be generated by the electronic device 404 in response to an end user acknowledging the signal while using the application and/or the operating system and during a time in which the signal is emitted by the video game controller 120.

As shown in FIG. 4D, after receiving and/or in response to receiving the notification 408 from the electronic device 404, the video game controller 120 can obtain payment method information. For example, the payment method information can be obtained from a server 414 (e.g., a cloud-based storage server that stores payment method information for video game players) which transmits a message 412 to the video game controller 120 that includes the payment method information. In another example, the payment method information for the video game player can be obtained from the electronic device 404 which transmits a message 416 to the video game controller 120 that includes the payment method information (e.g., from a digital wallet associated with the electronic device 404 or video game system application installed and executing on the electronic device 404). In some implementations, the payment method information can facilitate making purchases using the video game controller 120, the video game console 110, the electronic device 404, an application associated with a provider of the video game console 110 that is installed on and/or executing on the electronic device 404, or a combination thereof. After receiving and/or in response to receiving the payment method information, the video game controller 120 can transmit a message 410 that includes the payment method information to the video game console 110. After receiving and/or in response to receiving the payment method information, the video game console 110 can generate a GUI 496 and present the GUI 496 on the display 130. The GUI 496 can present a message that indicates that the payment method information was received.

As shown in FIG. 4E, after receiving and/or in response to receiving the message 410 that includes the payment method information from the video game controller 120, the video game console 110 can perform a payment event. In some implementations, to perform the payment event, the video game console 110 can verify the payment method information by transmitting a message 416 to a server 120 (e.g., a cloud-based server with a credential authentication service) and receiving a message 418 from the server 418 that indicates that the payment method associated with the payment method information is authenticated and/or valid. In some implementations, the payment method can be used by the video game console 110 and/or a video game executing on the video game console 110 to make a purchase (e.g., a game purchase from a game store, an in-app purchase, a merchandise purchase from a web store, a food purchase from a food delivery service, and the like), authenticate an end user or video game player, join a multiplayer game, buy gaming credits (e.g., for a tournament, expo, and/or arcade), update video game player settings, manage video game player preferences, and the like. After authenticating and/or validating the payment method, the video game console 110 can generate a GUI 498 and present the GUI 498 on the display 130. The GUI 498 can present a message that indicates that the payment method was processed successfully. In some implementations, the message can serve as a response to the event.

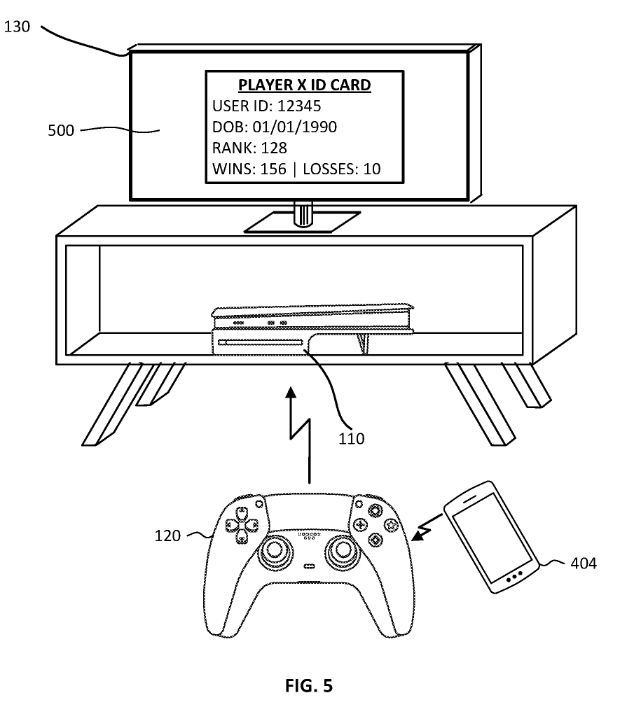

As described above, the event can correspond to a payment method inquiry generated by the video game console 110. However, this is not intended to be limiting, and the event can correspond to an inquiry for acquiring an ID card associated with a video game player. For example, a video game player may be using the video game console 110 to play a video game and may wish to provide information describing their characteristics as a video game player (e.g., the user ID of the video game player, and their date of birth, rank, and win/loss record) to their account, the video game console 110, the video game they are playing, to another video game player, and so on. In this case, the video game console 110 can generate a GUI and present the GUI on the display 130. The GUI can present the inquiry for acquiring the ID card associated with the video game player on the display 130. After the event has occurred and/or in response to the event occurring, the video game console 110 can transmit a notification to the video game controller 120. The video game controller 120 can then proceed according to a flow similar to flow described above with respect to FIGS. 4B-4D to transfer the video game player’s ID card to the video game console 110. In this case, the message 412 and/or 416 includes the video game player’s ID card and the video game controller transmits the video game player’s ID card to the video game console 110 in the message 410. After receiving and/or in response to receiving the ID card, as shown in FIG. 5, the video game console 110 can generate a GUI 500 and present the GUI 500 on the display 130. The GUI 500 can present the ID card on the display 130 and/or a message that indicates that the ID card was successfully received. In this way, the video game player can seamlessly transfer their ID card to the video game console 110 without interrupting video game play and without negatively impacting performance of the video game console.

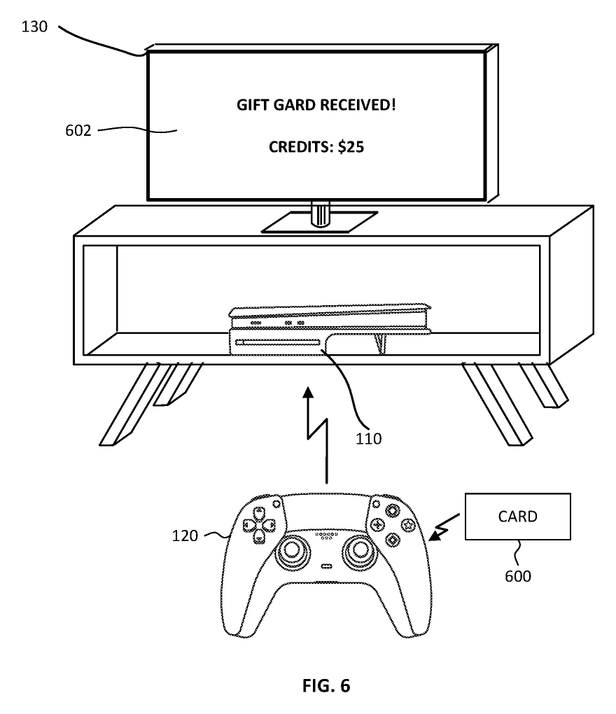

As described above, the payment method information can be transmitted in the message 416 from the electronic device 404 to the video game controller 120. However, this is not intended to be limiting, and the payment method information can be transmitted from a card 600 such as a credit card or a gift card to the video game controller 120. For example, a video game player may be using the video game console 110 to play a video game and may wish to provide payment method information for buying game credits, making an in-app purchase, and the like, to the video game console 110. In response, the video game controller 120 can proceed according to a flow similar to the flow described above with respect to FIGS. 4A-4D to obtain the payment method information from the card 400. For example, the card 600 can transmit a message that include the payment method information to the video game controller 120 and the video game controller 120 can transmit the message to the video game console 110. After receiving and/or in response to receiving the payment method information from the card 600, as shown in FIG. 6, the video game console 110 can generate a GUI 602 and present the GUI 602 on the display 130. The GUI 602 can present a message that indicates that the gift card was successfully received and other information such as a balance of the gift card. In this way, the video game player can seamlessly transfer their payment method information to the video game console 110 even in cases in which the video game player’s electronic device is not readily accessible or the video game player does not have an electronic device.

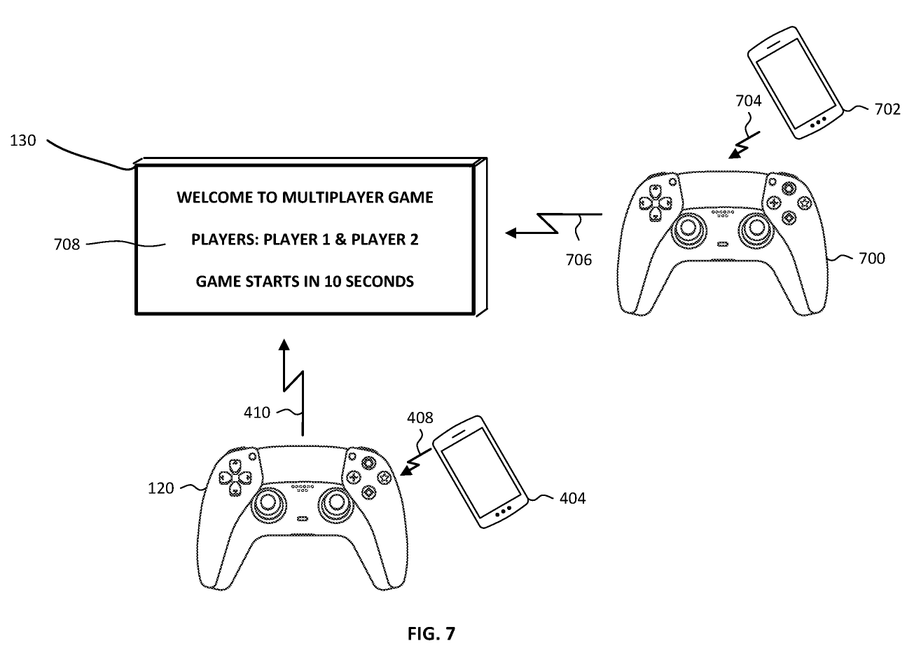

As described above, the event can correspond to a payment method inquiry generated by the video game console 110. However, this is not intended to be limiting, and the event can correspond to an inquiry for facilitating a multiplayer video game. For example, a video game player may be using the video game console 110 to play a video game and may wish to transform the video game into a multiplayer game and/or switch the video game to a multiplayer video game. In this case, the video game console 110 can generate a GUI and present the GUI on the display 130. The GUI can present the inquiry for facilitating a multiple video game. For example, the GUI can present an inquiry that solicits video game players for the multiplayer video game on the display 130. After the event has occurred and/or in response to the event occurring, as shown in FIG. 7, the video game console (not shown) can transmit a notification to the video game controller 120 and/or another video game controller 700. The video game controller 120 and the video game controller 700 can then proceed according to a flow similar to the flow described above with respect to FIGS. 4B and 4C. After receiving and/or in response to receiving the notification 408 from the electronic device 404, the video game controller 120 can transmit the message 410 that indicates the intent of the video game controller 120 to join the multiplayer game to the video game console. Similarly, after receiving and/or in response to receiving the notification 704 from the electronic device 700 (which is the same type of notification as the notification 408 sent from the electronic device 404 to the video game controller 120), the video game controller 700 can transmit the message 706 that indicates the intent of the video game controller 700 intent to the join the multiplayer game to the video game console. After receiving and/or in response to receiving the message 410 and/or message 706, the video game console 110 can generate a GUI 708 and present the GUI 708 on the display 130. The GUI 708 can present a message that indicates that the video game is a multiplayer video game, the video game players who have joined the multiplayer video game, and indication as to when the multiplayer video game will start. In this way, video game players can seamlessly participate in multiplayer video games without interrupting video game play and without negatively impacting performance of the video game console 110.

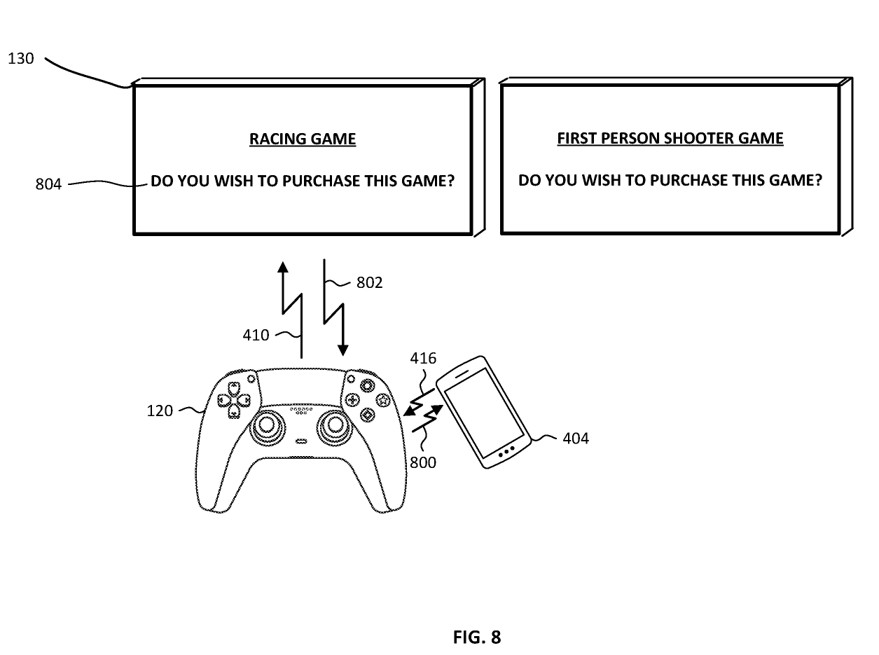

As described above, the event can correspond to a payment method inquiry generated by the video game console 110. However, this is not intended to be limiting, and the event can correspond to an inquiry for facilitating a video game purchase. For example, a video game player may visit a video game store and/or video game expo in which video games that are offered for sale are on display in a demonstration mode and the like and may wish to purchase one or more of the video games that are being demonstrated. In this case, the video game store and/or video game expo may present video games on displays as demonstrations. The displays may have associated video game controllers and video game consoles. For example, as shown in FIG. 8, a display 130 may have a video game controller 120 for facilitating demonstration of the video game presented on the display 130. The video game console (not shown) can generate a GUI 804 and present the GUI 804 on the display 130. The GUI 804 can present the inquiry for facilitating purchase of the video game that is being demonstrated. For example, the GUI can present an inquiry that asks a viewer of the display “Do you wish to purchase this game?” on the display 130. After the event has occurred and/or in response to the event occurring, as shown in FIG. 8, the video game console (not shown) can transmit a notification (not shown) to the video game controller 120 and/or another video game controller (e.g., a video game controller associated with another demonstrative display). The video game controller 120 can then proceed according to a flow similar to the flow described above with respect to FIGS. 4B-4D. After receiving and/or in response to receiving the message 416 from the electronic device 404 that includes the payment method information, the video game controller 120 can transmit the message 410 that indicates the payment method information to the video game console (not shown). After receiving the message 410, the video game console (not shown) and/or display 130 can facilitate the purchase of the video game, add the purchased video game to a video game hub associated with the video game player, and transmit a message 802 to the video game controller 120 with an indication of the video game that was purchased. After receiving the message 802, the video game controller 120 can transmit a message 800 to the electronic device 404 with the indication of the video game that was purchased. After receiving the message 800, the video game player can use the electronic device 404 to access the video game hub and the purchased video game. In this way, video game players can seamlessly purchase video games even without having access to their video game console and/or video game controller.

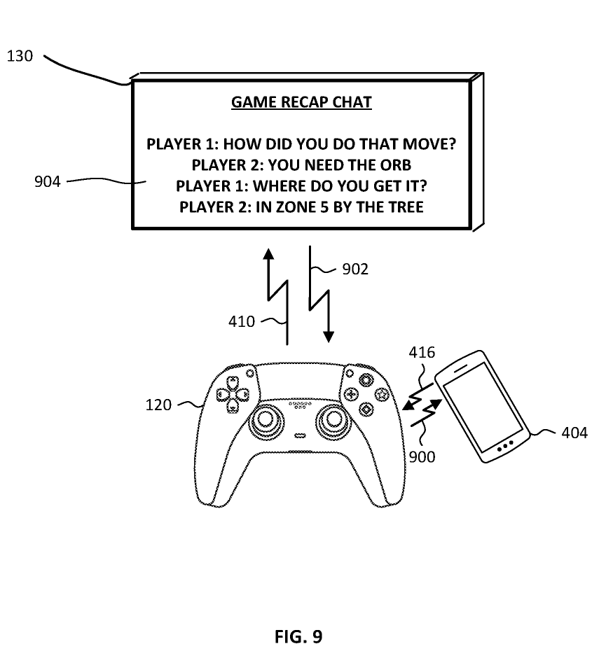

As described above, the event can correspond to a payment method inquiry generated by the video game console 110. However, this is not intended to be limiting, and the event can correspond to an inquiry for facilitating the transfer of audio content, image content, web content, and/or text content associated with a video game. For example, a video game player may be playing a video game and/or have played a video game in which content such as audio content, image content, web content, and/or text content was generated before and/or after game play and may which to transfer that content to another device such as their video game controller and/or electronic device. The audio content and the image content can be associated with a video game that is executing on the video game console and/or has executed on the video game console (e.g., an audio recording of a conversation between video game players, audio or video captured during the game play of the video game, video game audio and/or video, a screen capture or video recording of the game play, a video recording of a video game player playing the video game, and the like). The web content can be associated with the video game and acquired by the video game console from an application, a cloud-based server, and/or the Internet (e.g., a website, a generative AI model response, video game content such as cheats, information, statistics, rankings, and the like). In some implementations, the text content can be associated with the video game and one or more video game players playing the video game and/or that have played the video game (e.g., a text conversation between the video game players and/or the video game player and a chatbot, a transcribed audio conversation between the video game players and/or the video game player and a chatbot, and the like). In this case, the video game console (not shown) can generate a GUI and present the GUI on the display 130. The GUI can present the inquiry for facilitating transfer of the content 904 (FIG. 9) that is being displayed (e.g., a game recap chat). After the event has occurred and/or in response to the event occurring, as shown in FIG. 9, the video game console (not shown) can transmit a notification (not shown) to the video game controller 120. The video game controller 120 can then proceed according to a flow similar to the flow described above with respect to FIGS. 4B and 4C. After receiving and/or in response to receiving the notification 408 from the electronic device 404, the video game controller 120 can transmit the message 410 that includes a request for content to the video game console (not shown). After receiving the message 410, the video game console (not shown) and/or display 130 can facilitate the transfer of the content in a message 902 to the video game controller 120. After receiving the message 902, the video game controller 120 can transmit a message 900 to the electronic device 404 that includes the content. After receiving the message 900, the video game player can use the electronic device 404 to access, view, and further transfer the content. In this way, video game players can seamlessly transfer content associated with video game play without interrupting video game play and without negatively impacting performance of the video game console.

While the examples described throughout have been described as separate examples, this is not intended to be limiting, and each of the examples and described techniques can be used with each of the other examples and described techniques. In this way, the techniques described throughout can facilitate video game controller-driven information transfer separately and in combination with one another. Additionally, while the foregoing has been described with respect to a video game controller and video game console, this is not intended to limiting and other arrangements without departing from the spirit of the disclosed techniques are possible. For example, a simulated video game console may be incorporated as part of and/or built into the display and the video game controller may transmit and/or communicate directly with the display. In another example, another electronic device such as a mobile phone may serve as a simulated video game controller, and the disclosed techniques can facilitate information from one electronic device to another electronic device and so on. In a further example, an electronic device may transmit and/or communicate directly with the display, which in turn may communicate directly with a cloud gaming server. In this case, information may be transferred directly from the electronic device to the display without using a dedicated video game controller. In this way, the techniques described herein can be used in environments in which a video game console and/or video game controller is not present.

FIG. 10 depicts an example of a process 1000 for operating a video game controller to perform video game controller-driven information transfer. The process depicted in FIG. 10 may be implemented in software (e.g., code, instructions, program) executed by one or more processing units (e.g., processors, cores) of the respective systems, hardware, or combinations thereof. The software may be stored on one or more non-transitory storage media (e.g., on a memory device). The process shown in FIG. 10 and described below is intended to be illustrative and non-limiting. Although FIG. 10 depicts the various steps occurring in a particular sequence or order, this is not intended to be limiting. In certain alternative embodiments, the steps may be performed in some different order or some steps may also be performed in parallel. In certain embodiments, such as in the embodiments depicted in FIGS. 1-9, the process shown FIG. 10 may be performed by the video game controller 120.

At block 1002, the video game controller receives an event notification from a video game console. In some implementations, the video game console is wirelessly coupled to the video game controller. The event notification can indicate that an event has occurred at the video game console. In some implementations, the event corresponds to a payment method inquiry generated by the video game console for facilitating the acquisition of payment method information by the video game console and/or a video game executing on the video game console. In some implementations, the payment method inquiry facilitates the acquisition of payment method information from a video game controller, an electronic device communicatively coupled to the video game console and/or the video game controller, a server communicatively coupled to the video game console and/or the video game controller, an end user of the video game console, the video game controller, and/or the electronic device, and/or some other source.

At block 1004, the video game controller detects that an electronic device is within a predetermined distance from the video game controller. In some implementations, the predetermined distance can be 0, 1, 2, 3, 4, 5, 6, 7, 8, 9, 10, 11, or 12 inches or any distance therebetween.

In some implementations, the video game controller can detect that the electronic device is within the predetermined distance from the video game controller by detecting a signal that is emitted from the electronic device. In some implementations, the signal can be an audio signal, a light signal, or a combination thereof. In some implementations, in the case the electronic device emits an audio signal, the video game controller can detect the emitted audio signal (e.g., using one or more audio transducers of the video game controller). In some implementations, to determine whether electronic device is within the predetermined distance from the video game controller, the video game controller can determine whether the audio signal emitted by the electronic device has a particular frequency and/or a particular amplitude. In the event that the audio signal emitted by the electronic device has the particular frequency and/or the particular amplitude, the video game controller can determine that the electronic device is within the predetermined distance from the video game controller. While the foregoing has been described with respect to a particular frequency and/or a particular amplitude, this is not intended to be limiting, and any audio feature such as tone, melody, harmony, and the like can be used in determining whether the electronic device is within the predetermined distance. In some implementations, in the case the electronic device emits a light signal, the video game controller can detect the emitted light signal (e.g., using one or more image sensors and/or light sensors of the video game controller). In some implementations, to determine whether electronic device is within the predetermined distance from the video game controller, the video game controller can determine whether the light signal emitted by the electronic device has a particular frequency, a particular intensity (e.g., brightness), and/or a particular pattern. In the event that the light signal emitted by the electronic device has the particular frequency, the particular intensity, and/or the particular pattern, the video game controller can determine that the electronic device is within the predetermined distance from the video game controller. While the foregoing has been described with respect to a particular frequency, a particular intensity, and particular pattern, this is not intended to be limiting, and any light feature such as an image, projection, hologram, and the like can be used in determining whether the electronic device is within the predetermined distance.

In some implementations, the video game controller can detect that the electronic device is within the predetermined distance from the video game controller by detecting that the electronic device is communicating with the video game controller using at least one of a Near Field Communication (NFC) protocol or a Bluetooth protocol. In some implementations, the video game controller can be wirelessly paired with and/or wirelessly coupled to the electronic device using a wireless pairing and/or coupling protocol such as the NFC protocol or Bluetooth protocol and the electronic device can be considered to be communicating with the video game controller when the video game controller is wirelessly paired with and/or wirelessly coupled to the electronic device. In some implementations, to determine whether the electronic device is within the predetermined distance from the video game controller, the video game controller can determine whether the video game controller is wirelessly paired with and/or wirelessly coupled to the electronic device using the NFC protocol and/or the Bluetooth protocol, and, in the event that the video game controller detects that the video game controller is wirelessly paired with and/or wirelessly coupled to the electronic device using the NFC protocol and/or the Bluetooth protocol, the video game controller can determine that the electronic device is within the predetermined distance from the video game controller. While the foregoing has been described with respect to the NFC and Bluetooth protocols, this is not intended to be limiting, and any wireless communication protocol capable of wirelessly pairing and/or wirelessly coupling a video game controller and an electronic device can be used in determining whether the electronic device is within the predetermined distance.

In some implementations, the video game controller can detect that the electronic device is within the predetermined distance from the video game controller by detecting that the electronic device is in physical contact with the video game controller and/or has physically contacted the video game controller. In some implementations, the electronic device can be brought into physical contact with the video game controller and the video game controller can detect the electronic device is in physical contact with and/or has physically contacted the video game controller. The video game controller can detect whether the electronic device is physical contact with and/or has physically contacted the video game controller using one or more sensors (e.g., proximity sensors, IMUs) and/or a wireless communication transceiver (e.g., a Bluetooth-enabled radio, an NFC-enabled radio). In some implementations, to determine whether the electronic device is in physical contact with and/or has physically contacted the video game controller, the video game controller can obtain a signal from the wireless communication transceiver and use the signal obtained from the wireless communication transceiver to determine that an electronic device is within a close distance to the video game controller (e.g., 0, 1, 3, 4 inches or anything distance therebetween). In the event the video game controller determines that the electronic device is within a close distance to the electronic device, the video game controller can obtain one or more signals from the one or more sensors and use the one or more signals obtained from the one or more sensors to determine that the electronic device is in physical contact with and/or has physically contacted the video game controller. For example, in the case of a proximity sensor, the video game controller can obtain a signal from the wireless communication transceiver, use that signal to determine that the electronic device is within a close distance to the video game controller, obtain a signal from the proximity sensor, and use that signal to determine that the electronic device is in physical contact with (e.g., touching) the video game controller. In another example, in the case of an IMU, the video game controller can obtain a signal from the wireless communication transceiver, use that signal to determine that the electronic device is within a close distance to the video game controller, obtain signals from the IMUs, and use those signals to determine that the electronic device has physically contacted the video game controller while the electronic device is or was within the close distance to the video game controller.

At block 1006, the video game controller emits a signal. In some implementations, the signal can be an audible signal (e.g., a sound output by an audio transducer of the video game controller), a visual signal (e.g., a light emitted by a light source of the video game controller), a vibration signal (e.g., a rumble emitted by a vibrator of the video game controller), or a combination thereof.

At block 1008, the video game controller receives a notification from the electronic device. The notification can indicate that the signal emitted by the video game controller was received by the electronic device. In some implementations, the notification can also indicate that an application associated with a provider of the video game console is executing on the electronic device. In some implementations, the notification is generated automatically by the electronic device in response to receiving the signal while an application associated with a provider of the video game console is executing on the electronic device. In some implementations, the second notification is generated by the electronic device in response to an end user acknowledging the signal while using an application associated with a provider of the video game console that is executing on the electronic device and during a time in which the signal is emitted by the video game controller.

At block 1010, the video game controller receives a message from the electronic device. In some implementations, the message includes payment method information for a video game player associated with the video game controller. In some implementations, the video game player can be an end user of the video game console, an end user of the electronic device, an end user of the video game controller, or a combination thereof. In some implementations, the video game player can be human video game player or computerized (e.g., artificially intelligent) video game player (e.g., a bot). In some implementations, the payment method information for the video game player can be obtained from a server (e.g., a cloud-based storage server) storing payment method information for video game players, the electronic device, or a combination thereof. In some implementations, the payment method information can used to facilitate and manage video game purchases, video game credits, in-app purchases, and the like.

At block 1012, the video game controller transmits a message to the video game console. In some implementations, the message includes the payment method information and transmitting the message serves as a response to the event. The video game controller can transmit the message to the video game console using a wireless communication transceiver of the video game controller. In some implementations, the payment method information can be used by the video game console to facilitate and manage video game purchases, video game credits, in-app purchases, and the like.

FIG. 11 depicts an another example of a process 1100 for operating a video game controller to perform video game controller-driven information transfer. The process depicted in FIG. 11 may be implemented in software (e.g., code, instructions, program) executed by one or more processing units (e.g., processors, cores) of the respective systems, hardware, or combinations thereof. The software may be stored on one or more non-transitory storage media (e.g., on a memory device). The process shown in FIG. 11 and described below is intended to be illustrative and non-limiting. Although FIG. 11 depicts the various steps occurring in a particular sequence or order, this is not intended to be limiting. In certain alternative embodiments, the steps may be performed in some different order or some steps may also be performed in parallel. In certain embodiments, such as in the embodiments depicted in FIGS. 1-9, the process shown FIG. 11 may be performed by the video game controller 120.

At block 1102, the video game controller detects that an electronic device is within a predetermined distance from the video game controller. In some implementations, the predetermined distance can be 0, 1, 2, 3, 4, 5, 6, 7, 8, 9, 10, 11, or 12 inches or any distance therebetween.

In some implementations, the video game controller can detect that the electronic device is within the predetermined distance from the video game controller by detecting a signal that is emitted from the electronic device. In some implementations, the signal can be an audio signal, a light signal, or a combination thereof. In some implementations, in the case the electronic device emits an audio signal, the video game controller can detect the emitted audio signal (e.g., using one or more audio transducers of the video game controller). In some implementations, to determine whether electronic device is within the predetermined distance from the video game controller, the video game controller can determine whether the audio signal emitted by the electronic device has a particular frequency and/or a particular amplitude. In the event that the audio signal emitted by the electronic device has the particular frequency and/or the particular amplitude, the video game controller can determine that the electronic device is within the predetermined distance from the video game controller. While the foregoing has been described with respect to a particular frequency and/or a particular amplitude, this is not intended to be limiting, and any audio feature such as tone, melody, harmony, and the like can be used in determining whether the electronic device is within the predetermined distance. In some implementations, in the case the electronic device emits a light signal, the video game controller can detect the emitted light signal (e.g., using one or more image sensors and/or light sensors of the video game controller). In some implementations, to determine whether electronic device is within the predetermined distance from the video game controller, the video game controller can determine whether the light signal emitted by the electronic device has a particular frequency, a particular intensity (e.g., brightness), and/or a particular pattern. In the event that the light signal emitted by the electronic device has the particular frequency, the particular intensity, and/or the particular pattern, the video game controller can determine that the electronic device is within the predetermined distance from the video game controller. While the foregoing has been described with respect to a particular frequency, a particular intensity, and particular pattern, this is not intended to be limiting, and any light feature such as an image, projection, hologram, and the like can be used in determining whether the electronic device is within the predetermined distance.

In some implementations, the video game controller can detect that the electronic device is within the predetermined distance from the video game controller by detecting that the electronic device is communicating with the video game controller using at least one of a Near Field Communication (NFC) protocol or a Bluetooth protocol. In some implementations, the video game controller can be wirelessly paired with and/or wirelessly coupled to the electronic device using a wireless pairing and/or coupling protocol such as the NFC protocol or Bluetooth protocol and the electronic device can be considered to be communicating with the video game controller when the video game controller is wirelessly paired with and/or wirelessly coupled to the electronic device. In some implementations, to determine whether the electronic device is within the predetermined distance from the video game controller, the video game controller can determine whether the video game controller is wirelessly paired with and/or wirelessly coupled to the electronic device using the NFC protocol and/or the Bluetooth protocol, and, in the event that the video game controller detects that the video game controller is wirelessly paired with and/or wirelessly coupled to the electronic device using the NFC protocol and/or the Bluetooth protocol, the video game controller can determine that the electronic device is within the predetermined distance from the video game controller. While the foregoing has been described with respect to the NFC and Bluetooth protocols, this is not intended to be limiting, and any wireless communication protocol capable of wirelessly pairing and/or wirelessly coupling a video game controller and an electronic device can be used in determining whether the electronic device is within the predetermined distance.

In some implementations, the video game controller can detect that the electronic device is within the predetermined distance from the video game controller by detecting that the electronic device is in physical contact with the video game controller and/or has physically contacted the video game controller. In some implementations, the electronic device can be brought into physical contact with the video game controller and the video game controller can detect the electronic device is in physical contact with and/or has physically contacted the video game controller. The video game controller can detect whether the electronic device is physical contact with and/or has physically contacted the video game controller using one or more sensors (e.g., proximity sensors, IMUs) and/or a wireless communication transceiver (e.g., a Bluetooth-enabled radio, an NFC-enabled radio). In some implementations, to determine whether the electronic device is in physical contact with and/or has physically contacted the video game controller, the video game controller can obtain a signal from the wireless communication transceiver and use the signal obtained from the wireless communication transceiver to determine that an electronic device is within a close distance to the video game controller (e.g., 0, 1, 3, 4 inches or anything distance therebetween). In the event the video game controller determines that the electronic device is within a close distance to the electronic device, the video game controller can obtain one or more signals from the one or more sensors and use the one or more signals obtained from the one or more sensors to determine that the electronic device is in physical contact with and/or has physically contacted the video game controller. For example, in the case of a proximity sensor, the video game controller can obtain a signal from the wireless communication transceiver, use that signal to determine that the electronic device is within a close distance to the video game controller, obtain a signal from the proximity sensor, and use that signal to determine that the electronic device is in physical contact with (e.g., touching) the video game controller. In another example, in the case of an IMU, the video game controller can obtain a signal from the wireless communication transceiver, use that signal to determine that the electronic device is within a close distance to the video game controller, obtain signals from the IMUs, and use those signals to determine that the electronic device has physically contacted the video game controller while the electronic device is or was within the close distance to the video game controller.

At block 1104, the video game controller emits a signal. In some implementations, the signal can be an audible signal (e.g., a sound output by an audio transducer of the video game controller), a visual signal (e.g., a light emitted by a light source of the video game controller), a vibration signal (e.g., a rumble emitted by a vibrator of the video game controller), or a combination thereof.

At block 1106, the video game controller receives a notification from the electronic device. The notification can indicate that the signal emitted by the video game controller was received by the electronic device. In some implementations, the notification can also indicate that an application associated with a provider of the video game console is executing on the electronic device. In some implementations, the notification is generated automatically by the electronic device in response to receiving the signal while an application associated with a provider of the video game console is executing on the electronic device. In some implementations, the second notification is generated by the electronic device in response to an end user acknowledging the signal while using an application associated with a provider of the video game console that is executing on the electronic device and during a time in which the signal is emitted by the video game controller.

At block 1108, the video game controller receives a message from the video game console. In some implementations, the message includes audio content, image content, web content, and/or text content for a video game player associated with the video game controller. In some implementations, the video game player can be an end user of the video game console, an end user of the electronic device, an end user of the video game controller, or a combination thereof. In some implementations, the video game player can be human video game player or computerized (e.g., artificially intelligent) video game player (e.g., a bot). In some implementations, the audio content and the image content can be associated with a video game that is executing on the video game console and/or has executed on the video game console (e.g., an audio recording of a conversation between video game players, audio or video captured during the game play of the video game, video game audio and/or video, a screen capture or video recording of the game play, a video recording of a video game player playing the video game, and the like). In some implementations, the web content can be associated with the video game and acquired by the video game console from an application, a cloud-based server, and/or the Internet (e.g., a website, a generative AI model response, video game content such as cheats, information, statistics, rankings, and the like). In some implementations, the text content can be associated with the video game and one or more video game players playing the video game and/or that have played the video game (e.g., a text conversation between the video game players and/or the video game player and a chatbot, a transcribed audio conversation between the video game players and/or the video game player and a chatbot, and the like).

At block 1110, the video game controller transmits a message to the electronic device. In some implementations, the message includes the audio content, image content, web content, and/or text content. The video game controller can transmit the message to the electronic device using a wireless communication transceiver of the video game controller. In some implementations, the audio content, image content, web content, and/or text content can be used by the electronic device to present the content on a display of the electronic device and/or store the content on the electronic device, and/or transmit the content from the electronic device to another location and/or another electronic device.

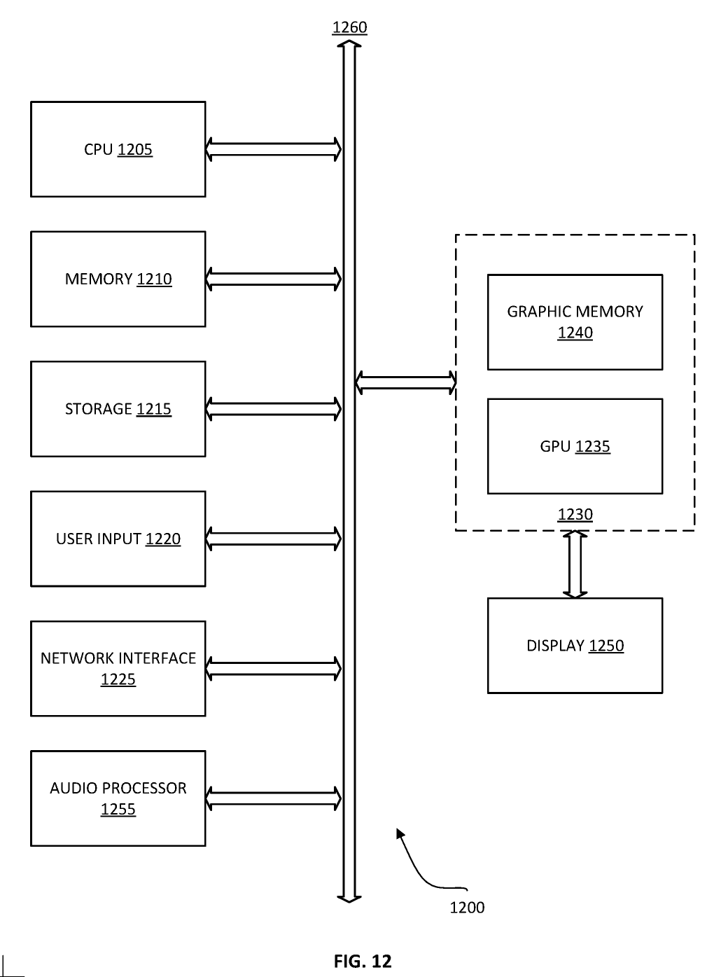

FIG. 12 illustrates an example of a computer system 1200 suitable for implementing techniques of the present disclosure. The computer system 1200 represents, for example, a user device (e.g., a touchscreen device or any other device described herein, above), a video game system, a backend set of servers, or other types of a computer system. The computer system 1200 includes a central processing unit (CPU) 1205 for running software applications and optionally an operating system. The CPU 1205 may be made up of one or more homogeneous or heterogeneous processing cores. Memory 1210 stores applications and data for use by the CPU 1205 (including possible any of the AI models and any program codes of applications described herein above). Storage 1215 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media (and may store any of the training data and/or user data described herein above). User input devices 1220 communicate user inputs from one or more users to the computer system 1200, examples of which may include keyboards, mice, joysticks, touch pads, touch screens, still or video cameras, and/or microphones. Network interface 1225 allows the computer system 1200 to communicate with other computer systems (including ones hosting any of the AI models described herein) via an electronic communications network and may include wired or wireless communication over local area networks and wide area networks such as the Internet. An audio processor 1255 is adapted to generate analog or digital audio output from instructions and/or data provided by the CPU 1205, memory 1210, and/or storage 1215. The components of computer system 1200, including the CPU 1205, memory 1210, data storage 1215, user input devices 1220, network interface 1225, and audio processor 1255 are connected via one or more data buses 1260.

A graphics subsystem 1230 is further connected with the data bus 1260 and the components of the computer system 1200. The graphics subsystem 1230 includes a graphics processing unit (GPU) 1235 and graphics memory 1240. The graphics memory 1240 includes a display memory (e.g., a frame buffer) used for storing pixel data for each pixel of an output image. The graphics memory 1240 can be integrated in the same device as the GPU 1235, connected as a separate device with the GPU 1235, and/or implemented within the memory 1210. Pixel data can be provided to the graphics memory 1240 directly from the CPU 1205. Alternatively, the CPU 1205 provides the GPU 1235 with data and/or instructions defining the desired output images, from which the GPU 1235 generates the pixel data of one or more output images. The data and/or instructions defining the desired output images can be stored in the memory 1210 and/or graphics memory 1240. In an embodiment, the GPU 1235 includes 3D rendering capabilities for generating pixel data for output images from instructions and data defining the geometry, lighting, shading, texturing, motion, and/or camera parameters for a scene. The GPU 1235 can further include one or more programmable execution units capable of executing shader programs.

The graphics subsystem 1230 periodically outputs pixel data for an image from the graphics memory 1240 to be displayed on the display device 1250. The display device 1250 can be any device capable of displaying visual information in response to a signal from the computer system 1200, including CRT, LCD, plasma, and OLED displays. The computer system 1200 can provide the display device 1250 with an analog or digital signal.

In accordance with various embodiments, the CPU 1205 is one or more general-purpose microprocessors having one or more processing cores. Further embodiments can be implemented using one or more CPUs 1205 with microprocessor architectures specifically adapted for highly parallel and computationally intensive applications, such as media and interactive entertainment applications.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically.

As used herein, when an action is “based on” something, this means the action is based at least in part on at least a part of the something. As used herein, the terms “substantially,” “approximately” and “about” are defined as being largely but not necessarily wholly what is specified (and include wholly what is specified) as understood by one of ordinary skill in the art. In any disclosed embodiment, the term “substantially,” “approximately,” or “about” may be substituted with “within [a percentage] of” what is specified, where the percentage includes 0.1, 1, 7, and 8 percent.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method for operating a video game controller, the method comprising:
detecting that an electronic device is within a predetermined distance from the video game controller, wherein the video game controller is wirelessly coupled to a video game console;
in response to detecting that the electronic device is within the predetermined distance from the video game controller, emitting a signal from the video game controller;
receiving a notification from the electronic device, the notification indicating that the signal was received by the electronic device;
in response to receiving the notification from the electronic device, receiving a first message from the electronic device, the first message comprising payment method information for a video game player associated with the video game controller; and
transmitting a second message from the video game controller to the video game console, wherein the second message comprises the payment method information, and wherein transmitting the second message serves as a response to an event that has occurred at the video game console.

2. The method of claim 1, further comprising:
prior to detecting that the electronic device is within the predetermined distance from the video game controller:
receiving an event notification from the video game console, the event notification indicating that the event has occurred at the video game console; and
in response to receiving the event notification from the video game console, detecting that the electronic device is within the predetermined distance from the video game controller.

3. The method of claim 1, wherein detecting that the electronic device is within the predetermined distance from the video game controller comprises detecting a signal emitted from the electronic device.

4. The method of claim 1, wherein detecting that the electronic device is within the predetermined distance from the video game controller comprises detecting that the electronic device is communicating with the video game controller using at least one of a Near Field Communication (NFC) protocol or a Bluetooth protocol.

5. The method of claim 1, wherein detecting that the electronic device is within the predetermined distance from the video game controller comprises detecting that the electronic device has physically contacted the video game controller.

6. The method of claim 1, wherein the notification further indicates that an application associated with a provider of the video game console is executing on the electronic device.

7. The method of claim 1, wherein the signal comprises at least one of an audible signal emitted from an audio transducer of the video game controller, a visual signal emitted from a light emitting unit of the video game controller, a vibration signal emitted from a vibrating unit of the video game controller, or a combination thereof.

8. A video game controller comprising:
one or more processors; and
one or more computer-readable media storing instructions which, when executed by the one or more processors, cause the video game controller to perform operations comprising:
detecting that an electronic device is within a predetermined distance from the video game controller, wherein the video game controller is wirelessly coupled to a video game console;
in response to detecting that the electronic device is within the predetermined distance from the video game controller, emitting a signal from the video game controller;
receiving a notification from the electronic device, the notification indicating that the signal was received by the electronic device;
in response to receiving the notification from the electronic device, receiving a first message from the electronic device, the first message comprising payment method information for a video game player associated with the video game controller; and
transmitting a second message from the video game controller to the video game console, wherein the second message comprises the payment method information, and wherein transmitting the second message serves as a response to an event that has occurred at the video game console.

9. The video game controller of claim 8, the operations further comprising:
prior to detecting that the electronic device is within the predetermined distance from the video game controller:
receiving an event notification from the video game console, the event notification indicating that the event has occurred at the video game console; and
in response to receiving the event notification from the video game console, detecting that the electronic device is within the predetermined distance from the video game controller.

10. The video game controller of claim 8, wherein detecting that the electronic device is within the predetermined distance from the video game controller comprises detecting a signal emitted from the electronic device.

11. The video game controller of claim 8, wherein detecting that the electronic device is within the predetermined distance from the video game controller comprises detecting that the electronic device is communicating with the video game controller using at least one of a Near Field Communication (NFC) protocol or a Bluetooth protocol.

12. The video game controller of claim 8, wherein detecting that the electronic device is within the predetermined distance from the video game controller comprises detecting that the electronic device has physically contacted the video game controller.

13. The video game controller of claim 8, wherein the notification further indicates that an application associated with a provider of the video game console is executing on the electronic device.

14. The video game controller of claim 8, wherein the signal comprises at least one of an audible signal emitted from an audio transducer of the video game controller, a visual signal emitted from a light emitting unit of the video game controller, a vibration signal emitted from a vibrating unit of the video game controller, or a combination thereof.

15. One or more non-transitory computer-readable media storing computer-readable instructions that, when executed by one or more processors, cause a video game controller to perform operations comprising:
detecting that an electronic device is within a predetermined distance from the video game controller, wherein the video game controller is wirelessly coupled to a video game console;
in response to detecting that the electronic device is within the predetermined distance from the video game controller, emitting a signal from the video game controller;
receiving a notification from the electronic device, the notification indicating that the signal was received by the electronic device;
in response to receiving the notification from the electronic device, receiving a first message from the electronic device, the first message comprising payment method information for a video game player associated with the video game controller; and
transmitting a second message from the video game controller to the video game console, wherein the second message comprises the payment method information, and wherein transmitting the second message serves as a response to an event that has occurred at the video game console.

16. The one or more non-transitory computer-readable media of claim 15, the operations further comprising:
prior to detecting that the electronic device is within the predetermined distance from the video game controller:
receiving an event notification from the video game console, the event notification indicating that the event has occurred at the video game console; and
in response to receiving the event notification from the video game console, detecting that the electronic device is within the predetermined distance from the video game controller.

17. The one or more non-transitory computer-readable media of claim 15, wherein detecting that the electronic device is within the predetermined distance from the video game controller comprises detecting a signal emitted from the electronic device.

18. The one or more non-transitory computer-readable media of claim 15, wherein detecting that the electronic device is within the predetermined distance from the video game controller comprises detecting that the electronic device is communicating with the video game controller using at least one of a Near Field Communication (NFC) protocol or a Bluetooth protocol.

19. The one or more non-transitory computer-readable media of claim 15, wherein detecting that the electronic device is within the predetermined distance from the video game controller comprises detecting that the electronic device has physically contacted the video game controller.

20. The one or more non-transitory computer-readable media of claim 15, wherein the notification further indicates that an application associated with a provider of the video game console is executing on the electronic device.
